(19) United States
(12) Patent Application Publication
(10) Pub. No.: US 2021/0224670 A1
(43) Pub. Date: Jul. 22, 2021

(54) ML FOR PROCESS MONITORING

(71) Applicant: HEXAGON TECHNOLOGY CENTER GMBH, Heerbrugg (CH)

(72) Inventor: Lukasz GOSIK, Scheidegg (DE)

(73) Assignee: HEXAGON TECHNOLOGY CENTER GMBH, Heerbrugg (CH)

(21) Appl. No.: 17/153,780

(22) Filed: Jan. 20, 2021

(30) Foreign Application Priority Data
Jan. 21, 2020 (EP) 20152993.0

(51) Int. Cl. G06N 5/04; G06N 20/00

(52) U.S. Cl. CPC G06N 5/04; G06N 20/00

(57) ABSTRACT

A computer program product providing an environment in which control software controlling at least one physical process is executed, wherein the control software is comprised of modular blocks termed actions, wherein the control software is defined through graph connections between the actions, wherein the computer program product provides for a monitoring functionality, wherein physical sub-processes of the at least one physical process influenced by an action may be monitored. A method for choosing which physical sub-processes are to be monitored is provided, wherein a user places a debug point on an action.

### CROSS-REFERENCE TO RELATED APPLICATIONS

This application claims priority to European Patent Application No. 20152993.0, filed on Jan. 21, 2020. The foregoing patent application is herein incorporated by reference.

### FIELD OF INVENTION

The present invention relates to a computer program product and a method for monitoring the behavior of at least one physical process.

### BACKGROUND

Physical processes deviate once in a while from desired behavior. In such a case, sensor data measuring observables associated to a physical process may be used to infer a changed state of the physical process. Outlier detection methods may be used for such a purpose. Outlier detection methods are well known (Chandola, V., Banerjee, A. & Kumar, V. (2007). Outlier detection: A survey. ACM Computing Surveys, 14, 15.). It is often desirable to operate on data streams, wherein the data streams may correspond to streams of sensor data measuring observables associated to a physical process, Outlier detection methods for such a purpose are known as well (Pokrajac, D., Lazarevic, A., & Latecki, L. J. (2007, March). Incremental local outlier detection for data streams. In 2007 IEEE Symposium on Computational intelligence and Data Mining (pp. 504-515). IEEE.).

Sensors recording observables are typically placed at a plurality of different locations. It also might be necessary to monitor different physical processes jointly, for deviating behavior may only be observable by studying the different physical processes in unison. In such a case, letting a user decide about which specific sensors to use for monitoring (parts of) the physical processes may provide sub-optimal monitoring results, as typical users of a physical process may not possess the required knowledge to choose from the available sensors.

### BRIEF DESCRIPTION

It is therefore an objective of some aspects of the present invention to provide for an improved interface to a user for monitoring (parts of) physical processes.

This objective is achieved by realizing at least part of the features of the independent claims. Features which further develop the invention in an alternative or advantageous manner are described in the dependent patent claims.

Some aspects of the invention relate to a computer program product providing an environment in which control software is executed, the control software controlling at least one physical process via at least one external software solution, wherein each controlled physical process is decomposable into at least one physical sub-process, the physical sub-processes of the controlled physical processes combinable into a nonempty set of physical sub-processes, the computer program product receiving as input sensor data recording observables of the at least one physical process, and monitoring information relating to which physical sub-processes from the set of physical sub-processes are to be monitored, wherein the control software is composed of at least one elementary building block, termed action, wherein the number and type of actions and the associations between actions determine the control software, wherein each of the at least one external software solutions provides interfaces through which actions may communicate with the external software solutions, wherein the monitoring information comprises at least one debug point, wherein each debug point is placed on an action to which is associated a nonempty subset of the set of physical sub-processes, wherein the sensor data recording observables which depend on the subset of the set of physical sub-processes associated to a debug point are stored in such a way in memory, the computer program product having access to memory configured to store data, that the stored data are relatable to the debug point, and to each debug point is associated a monitoring function having access to the parts of memory comprising sensor data related to the debug point, wherein the monitoring function provides an indication about a physical state of the subset of the set of physical sub-processes associated to the debug point, wherein a debug point and a monitoring function form a pair.

The placement of a debug point on an action determines which subset of the set of physical sub-processes is to be monitored. In the field of general software, debug points are typically also called breakpoints.

The external software typically provides the functionality needed for accessing the hardware realizing physical processes. As such, it may for example comprise device drivers. To the outside, the external software may provide an interface through which hardware may be controlled. To move a Coordinate Measuring Machine (CMM) along one axis, for example, an interface command may be available in the external software, wherein in the command the parameters (axis, movement distance, movement speed) may be specified, for example. The external software may translate such a command into actual instructions for a motor, for example, providing the desired motion of the CMM. The control software implemented in the environment provided by the computer program product according to the invention communicates with physical devices via the external software. Actions may internally comprise source code specifying a sequence of instructions to be sent to software interfaces of (potentially different) external software solutions providing interfaces to different physical processes.

In an embodiment of the computer program product according to one aspect of the invention, a debug point on an action allows for monitoring the physical state of the subset of the set of physical sub-processes associated to the debug point, wherein the monitored sub-processes comprise sub-processes belonging to physically remote physical processes, wherein the monitoring provides information about the joint physical state of the monitored sub-processes.

An individual action may—using the external software—control (parts of) different physical processes at once. Placing a debug point on an individual action may therefore allow for a joint monitoring of physically remote physical processes. Depending on how an action is structured internally, a joint monitoring of an arbitrary number of physically remote processes can be started by placing a single debug point on the action.

In another embodiment of the computer program product according to the invention, a monitoring function associated to at least one debug point is configured to provide anomaly detection on the stored data associated to the debug point, wherein anomalies in the stored data are identified by the monitoring function, the anomalies relating to physical changes in the subset of the set of physical sub-processes associated to the debug point.

In another embodiment of the computer program product according to the invention, the monitoring function implements an online unsupervised anomaly detection algorithm, in particular an incremental local outlier factor algorithm, wherein the monitoring function operates on the stream of sensor data recording observables which depend on the subset of the set of physical sub-processes associated to the debug point to which the monitoring function is associated.

In another embodiment of the computer program product according to the invention, the monitoring function implements a rule-based anomaly detection algorithm, wherein the monitoring function operates on the stream of sensor data recording observables which depend on the subset of the set of physical sub-processes associated to the debug point to which the monitoring function is associated, wherein the rules are adapted to the action on which the debug point is placed.

Different rules may be explicitly encoded into the monitoring function. The monitoring function may, for example, compute statistics of the sensor data which it accesses. Using such statistics and pre-encoded rules, the monitoring function may detect anomalies or changes in the monitored physical sub-processes.

In another embodiment of the computer program product according to the invention, a graphical user interface is provided, wherein actions are associated to each other via a graph, wherein a debug point is represented by a pin placed on an action.

The computer program product may provide for a graphical environment, in which actions can be assembled via drag-and-drop operations from a list of available actions. Treating actions as nodes of a graph and connecting the nodes in a desired manner, different physical processes may be executed by the control software.

In another embodiment of the computer program product according to the invention, upon the detection of an anomaly associated to a debug point, a visual change in the pin representing the debug point is displayed in the graphical user interface.

Once an anomaly or general change has been detected, the computer program product according to the invention may change some graphical feature of the pin representing the debug point for which the anomaly or change was detected. The change is preferentially embodied in such a way as to be easily visible by a user of the control software. Besides graphical changes in the pin, text notifications about the detected anomaly or general change may be provided as well.

In another embodiment of the computer program product according to the invention, different graphical forms of the pin representing the debug point are associated to different monitoring functions.

Different shapes or colors of pins may be used for differentiating different monitoring functions. It may also be possible to place multiple different debug points onto a single action, wherein the different debug points may be associated to different monitoring functions. In this way, different aspects of the behavior of (parts of) at least one physical process may be monitored jointly.

Some aspects of the invention relate to a method for monitoring the behavior of at least one physical sub-process using the computer program product according to the invention, a user placing a debug point with a paired monitoring function on an action to which is associated the at least one physical sub-process, and providing information about the behavior of the at least one physical sub-process with the monitoring function by analyzing the sensor data recording observables which are related to the at least one physical sub-process associated to the debug point.

A user assembling a control software in the environment provided by the computer program product according to the invention may place a debug point on an action which should be monitored. Depending on the type of debug point placed on the action, the user may choose to monitor different aspects of the behavior of the physical processes which are at least partly influenced by the action on which the debug point is placed.

### BRIEF DESCRIPTION OF THE DRAWINGS

The inventive system is described below in more detail purely by way of example with the aid of concrete exemplary embodiments illustrated schematically in the drawings, further advantages of the invention also being examined Identical elements are labelled with the same reference numerals in the figures. In detail:

FIG. 1 shows a schematic and illustrative depiction of the invention.

### DETAILED DESCRIPTION

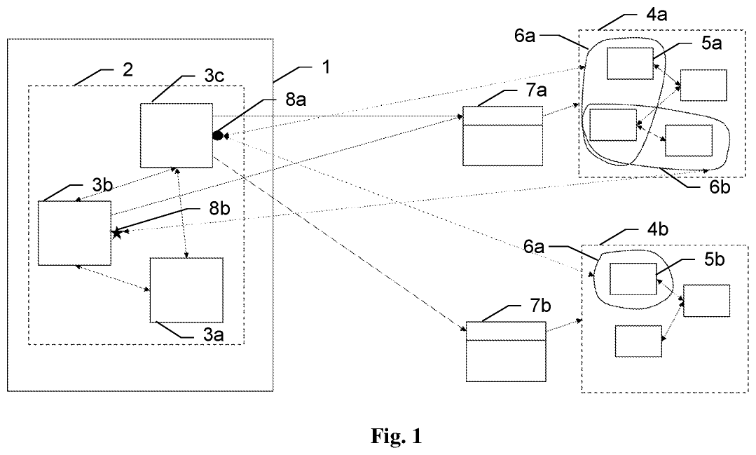

FIG. 1 shows a schematic and illustrative depiction of the invention. The computer program product according to the invention provides an environment 1 in which control software 2 may be executed. The control software 2 is used for controlling at least one physical process 4a,4b, wherein the control proceeds indirectly through external software 7a,7b, wherein the control software 2 calls the external software 7a,7b to control the execution of the at least one physical process 4a,4b. The control software 2 itself is assembled from modular blocks termed actions 3a,3b,3c. In FIG. 1, an exemplary illustration with three actions 3a,3b,3c is given. A graphical connection between different actions 3a,3b,3c determines the control software 2. Actions 3a,3b,3c may be connected in a bidirectional manner, or information may only flow in one direction from one action to another. Actions may communicate with the external software 7a,7b via interfaces provided by the external software 7a,7b. An action 3b,3c may communicate with the external software 7a, or an action 3a may only provide internal functionality for the control software 2.

A physical process 4a,4b may comprise physical sub-processes 5a,5b. Each physical process 4a,4b may comprise a different number of physical sub-processes 5a,5b. The physical sub-processes 5a,5b are typically influencing each other, wherein influencing is depicted in FIG. 1 via bidirectional graph connections between physical sub-processes 5a,5b.

An individual action 3c may at least partially control a plurality of physical processes 4a,4b. An action 3b,3c may control a subset 6a,6b,6c of physical sub-processes 5a,5b, wherein the controlled subset may comprise physical sub-processes corresponding to different physical processes. The “action” abstraction provided by the computer program product according to the invention therefore allows for distinct physical processes to be controlled at once using an individual action 3c.

Sensors record physical observables related to physical sub-processes 5a,5b. A control software 2 defined by an action graph controls at least one physical process 4a,4b. If a set of pre-defined actions are available to a user, the association of which physical sub-processes 5a,5b are influenced by which action may be pre-stored on the computing unit on which the control software is executed. A user graphically assembling a control software 2 therefore may not need to know about the associations of physical sub-processes 5a,5b to actions 3a,3b,3c. Such knowledge is encoded in the actions themselves. Having abstracted away the close connection between physical sub-processes 5a,5b and actions 3a,3b,3c, the user of the control software 2 may decide to monitor the behavior of the (parts of) physical processes 4a,4b influenced by an action. The user, however, does not need to know which physical sub-processes 5a,5b are specifically influenced by the action he chooses to monitor. Monitoring proceeds then by analyzing the sensor data provided by sensors associated to the physical sub-processes 5a,5b associated to the monitored action.

Monitoring may proceed in different forms. One way is unsupervised monitoring, wherein monitoring may be provided by a model which attempts to detect changes or outliers in the sensor data on which it operates. Such an unsupervised monitoring may operate directly on the stream of sensor data in an online fashion, or it may use stored sensor data for detecting anomalies that might have occurred in the past. In the latter case, monitoring an action requires allocating memory on a computing unit, wherein the memory may be typically allocated in a dynamic way, wherein the required amount of memory may depend on the length of the execution time of the monitored action. The monitoring method may, for example, be embodied as the incremental local outlier detection algorithm.

Monitoring may also be provided as supervised monitoring. For supervised monitoring, examples of typical failures and normal behavior of the physical sub-processes 5a,5b associated to a monitored action may have been gathered, and a supervised model might have been trained to detect normal or abnormal behavior of the monitored physical sub-processes 5a,5b.

Monitoring functionality is provided by the computer program product 1 according to the invention by enabling debug points 8a,8b which can be placed on individual actions 3a,3b,3c. A debug point 8a,8b may be represented by a pin, wherein different shapes or colors of pins may be provided by the computer program product 1 according to the invention. Different types of pins representing debug points 8a,8b may be associated to different monitoring functions. A debug point 8a,8b according to the invention placed on an action by a user does not stop the execution of the at least one physical process 4a,4b controlled by the control software 2. Instead, the monitoring function associated to the placed debug point 8a,8b monitors the sensor data provided by the sensors recording observables of the physical sub-processes 5a,5b associated to the action 3b,3c on which the debug point 8a,8b is placed. The computer program product according to the invention may restrict the actions on which debug points 8a,8b can be placed by a user, for example by requiring that actions on which debug points can be placed influence at least one physical process 4a,4b.

The pairing between debug points 8a,8b and monitoring functions according to the invention may enable a user to monitor (parts of) physical processes 4a,4b without knowing the detailed structure of processes. The graphical environment 1 provided by the computer program product according to the invention may allow for rapid and intuitive development of control software 2, wherein complicated interactions between different physical processes 4a,4b may be simply monitored by placing debug points 8a,8b according to the invention on actions 3a,3b,3c considered to be important by a user of the control software 2.

It goes without saying that the illustrated figure is merely a schematic of possible exemplary embodiments.

Although the invention is illustrated above, partly with reference to some preferred embodiments, it must be understood that numerous modifications and combinations of different features of the embodiments can be made. All of these modifications lie within the scope of the appended claims.

What is claimed is:

1. A computer program product providing an environment in which control software is executed, the control software controlling at least one physical process via at least one external software solution, wherein each controlled physical process is decomposable into at least one physical sub-process, the physical sub-processes of the controlled physical processes combinable into a nonempty set of physical sub-processes, the computer program product receiving as input:
sensor data recording observables of the at least one physical process, and
monitoring information relating to which physical sub-processes from the set of physical sub-processes are to be monitored,
wherein the control software comprises:
at least one elementary building block, termed action, wherein the number and type of actions and the associations between actions determine the control software, wherein each of the at least one external software solutions provides interfaces through which actions may communicate with the external software solutions, wherein the monitoring information comprises at least one debug point, wherein each debug point is placed on an action to which is associated a nonempty subset of the set of physical sub-processes, wherein the sensor data recording observables which depend on the subset of the set of physical sub-processes associated to a debug point are stored in memory, the computer program product having access to the memory, that the stored data are relatable to the debug point, and to each debug point is associated a monitoring function having access to the parts of memory comprising sensor data related to the debug point, wherein the monitoring function provides an indication about a physical state of the subset of the set of physical sub-processes associated to the debug point, wherein a debug point and a monitoring function form a pair.

2. A computer program product according to claim 1, wherein a debug point on an action allows for monitoring the physical state of the subset of the set of physical sub-processes associated to the debug point, wherein the monitored sub-processes comprise sub-processes belonging to physically remote physical processes, wherein the monitoring provides information about the joint physical state of the monitored sub-processes.

3. A computer program product according to claim 1, wherein a monitoring function associated to at least one debug point is configured to provide anomaly detection on the stored data associated to the debug point, wherein anomalies in the stored data are identified by the monitoring function, the anomalies relating to physical changes in the subset of the set of physical sub-processes associated to the debug point.

4. A computer program product according to claim 3, wherein the monitoring function implements an online unsupervised anomaly detection algorithm, wherein the monitoring function operates on the stream of sensor data recording observables which depend on the subset of the set of physical sub-processes associated to the debug point to which the monitoring function is associated.

5. A computer program product according to claim 3, wherein the monitoring function implements a rule-based anomaly detection algorithm, wherein the monitoring function operates on the stream of sensor data recording observables which depend on the subset of the set of physical sub-processes associated to the debug point to which the monitoring function is associated, wherein the rules are adapted to the action on which the debug point is placed.

6. A computer program product according to claim 1, wherein a graphical user interface is provided, wherein actions are associated to each other via a graph, wherein a debug point is represented by a pin placed on an action.

7. A computer program product according to claim 7, wherein upon the detection of an anomaly associated to a debug point, a visual change in the pin representing the debug point is displayed in the graphical user interface.

8. A computer program product according to claims 6, wherein different graphical forms of the pin representing the debug point are associated to different monitoring functions.

9. A method for monitoring the behavior of at least one physical sub-process using the computer program product according to claim 1, wherein placing a debug point with a paired monitoring function on an action to which is associated the at least one physical sub-process, and providing information about the behavior of the at least one physical sub-process with the monitoring function by analyzing the sensor data recording observables which are related to the at least one physical sub-process associated to the debug point.
